(19) United States
(12) Patent Application Publication
(10) Pub. No.: US 2025/0179347 A1
(43) Pub. Date: Jun. 5, 2025

(54) OLIGO(ETHYLENE GLYCOL) ALKYL ACRYLATE COPOLYMERS FOR CONTROLLING GAS HYDRATES IN A SOUR ENVIRONMENT

(71) Applicant: Saudi Arabian Oil Company, Dhahran (SA)

(72) Inventors: Muhammad Imran Ul-haq, Dhahran (SA); Mram Alyami, Riyadh (SA); Qasim Saleem, Khobar (SA); Taras Yurievich Makogon, Hedwig Village, TX (US); Rashed Mohammad Aleisa, Dhahran (SA); Venkateswara Reddy Ganugapenta, Ras Tannurah (SA)

(21) Appl. No.: 18/525,110

(22) Filed: Nov. 30, 2023

(51) Int. Cl. C09K 8/524

(52) U.S. Cl. CPC C09K 8/524; C09K 2208/22

(57) ABSTRACT

This disclosure relates to oligo(ethylene glycol) alkyl acrylate-based copolymers that are useful as kinetic hydrate inhibitors. Also provided are methods of preventing or inhibiting the formation of gas hydrates in natural gas, such as in a sour gas environment, using the kinetic hydrate inhibitors.

### TECHNICAL FIELD

This document relates to oligo(ethylene glycol) alkyl acrylate-based copolymers and methods of using the copolymers as kinetic hydrate inhibitors in sour gas environment to prevent or control the formation of gas hydrates.

### BACKGROUND

Clathrate hydrates (or gas hydrates) are solid crystalline materials made up of water molecules that enclathrate a natural gas guest molecule such as methane. The conditions favoring the formation of clathrate hydrates, such as low temperatures and high pressures, are often found in natural gas pipelines. With the expansion of offshore gas exploration and production, gas hydrate formation has become a serious operational concern in gas transportation and processing. Hydrate formation in gas lines poses serious safety and economic concerns as hydrates can plug pipelines, damage equipment, and affect downstream facilities. In gas production, prevention of gas hydrate formation is required to avoid lower capacity production, discontinuities, or total shutdowns.

Several methods are typically used to either prevent or inhibit natural gas clathrate hydrates. Kinetic hydrate inhibitors (KHIs) are often added to the pipeline fluids. These inhibitors are field specific where conditions and operational parameters may vary from one place to another: temperature, pressure, stream chemicals composition, compatibility with other additives, e.g. corrosion inhibitors or pipeline coating material. This implies that testing methods or protocols are required before field implementation as each gas field has different operational conditions, different natural gas chemical composition, different chemical treatment protocol, such as scale or corrosion inhibitors.

Though polymer products have been commercialized and used as KHIs, it is still challenging to find polymers and KHIs that can inhibit gas hydrates with a gas composition specifically rich in hydrogen sulfide and carbon dioxide under very low temperature and high pressure. The inhibition of gas hydrates formed under a sour (H₂S) environment is more difficult and challenging than under a non-sour gas mixture. In part, this is because the available KHIs for sour gas systems suffer from performance limitations, such as in terms of subcooling temperature. The existing solution is limited to a few degrees of subcooling.

Accordingly, there is a need for KHIs that can be used in a sour environment to control or prevent formation of gas hydrates, particularly during the production, transportation, and processing of natural gas containing H₂S and CO₂.

### SUMMARY

Provided in the present disclosure is a kinetic hydrate inhibitor (KHI) copolymer of Formula (I):

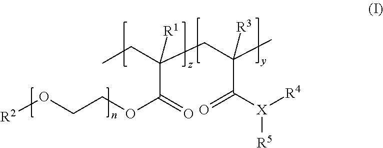

wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and

$$y + z = 1 ;$$

wherein the average molecular weight is from about 500 g/mol to about 10,000 g/mol; and
wherein R⁴ is absent when X is O or S.

In some embodiments, X is N.

In some embodiments, R¹, R², R³, R⁴, and R⁵ are each independently selected from the group consisting of H and C₁₋₆ alkyl.

In some embodiments, R¹ is H. In some embodiments, R¹ is C₁₋₆ alkyl.

In some embodiments, R² is C₁₋₆ alkyl.

In some embodiments, R³ is H.

In some embodiments, R⁴ is H.

In some embodiments, R⁵ is C₁₋₆ alkyl.

In some embodiments, n is 1 or 2.

In some embodiments, z is 0.25, 0.5, or 0.75.

In some embodiments, the average molecular weight is from about 500 g/mol to about 5,000 g/mol.

In some embodiments, X is N; R¹ is H or C₁₋₆ alkyl; R² is C₁₋₆ alkyl; R³ is H; R⁴ is H; R⁵ is C₁₋₆ alkyl; and n is 1 or 2. In some embodiments, R¹ is ethyl or methyl. In some embodiments, R² is ethyl. In some embodiments, R⁵ is isopropyl.

Also provided in the present disclosure is a method of preparing a KHI copolymer of claim 1, the method including reacting N-isopropyl acrylamide (NIPAM) with a monomer selected from 2-di(ethylene glycol) ethyl ether acrylate (DEGA) and ethoxyethyl methacrylate (EEM) in the presence of an azo initiator and a chain transfer agent; and forming the KHI copolymer.

In some embodiments of the method, the monomer is DEGA. In some embodiments, the monomer is EEM.

In some embodiments of the method, the azo initiator is selected from the group consisting of azoisobutyronitrile, 4,4′-azobis(4-cyanovaleric acid), 1,1′-azobis(cyclohexanecarbonitrile), 2,2′-azobis(2-methylpropionamidine) dihydrochloride, 2,2′-azobis(2-methylpropionitrile), 2,2′-azobis(2-methylpropionitrile), 2,2′-azobisisoheptonitrile, and 2,2′-azobis[2-(2-imidazolin-2-yl)propane]dihydrochloride. In some embodiments, the azo initiator is 4,4′-azobis(4-cyanovaleric acid).

In some embodiments of the method, the chain transfer agent is selected from the group consisting of thioglycolic acid, esters of thioglycolic acid, mercaptopropionic acid, esters of mercaptopropionic acid, mercaptobutanoic acid, and esters of mercaptobutanoic acid. In some embodiments, the chain transfer agent is thioglycolic acid.

Also provided in the present disclosure is a method of inhibiting the formation of gas hydrates in natural gas, the method including adding a composition including a kinetic hydrate inhibitor (KHI) copolymer of Formula (I) to a natural gas stream:

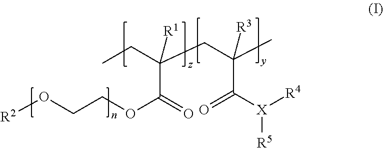

wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and

$$y + z = 1 ;$$

wherein the average molecular weight is from about 500 g/mol to about 10,000 g/mol; and
wherein R⁴ is absent when X is O or S;

thereby inhibiting the formation of gas hydrates in the natural gas.

In some embodiments of the method, X is N.

In some embodiments of the method, R¹, R², R³, R⁴, and R⁵ are each independently selected from the group consisting of H and C₁₋₆ alkyl.

In some embodiments of the method, the composition includes a solvent selected from an alcohol, an ether, a glycol, or combinations thereof.

In some embodiments of the method, the natural gas is sour gas.

In some embodiments of the method, the composition inhibits gas hydrate formation at a pressure of about 20 bars to about 200 bars. In some embodiments, the composition inhibits gas hydrate formation at a temperature of about 0° C. to about 20° C.

### DESCRIPTION OF DRAWINGS

FIG. 1 shows the ¹H NMR spectra of NIPAM, DEGA, EEM, p(NIPAM:DEGA) (50:50), and p(NIPAM:EEM) (50:50) in DMSO-d₆.

FIG. 2 shows the quantitative ¹³C{¹H}NMR spectrum of p(NIPAM:DEGA) (75:25) in DMSO-d₆. The chemical shift region in which the methyl groups of NIPAM (22.40 ppm) and DEGA (15.09 ppm) were observed is magnified for clarity.

FIGS. 3A-3D depict the mass spectra of exemplary KHI polymers obtained by ESI-ToF MS analysis.

FIG. 4 depicts the impact of the hydrophobic/hydrophilic ratio on the performance of exemplary KHI polymers.

FIG. 5 shows the impact of the solvent system on the performance of exemplary KHI polymers.

### DETAILED DESCRIPTION

The present disclosure relates to oligo(ethylene glycol) alkyl acrylate-based kinetic hydrate inhibitor (KHI) copolymers. The KHI copolymers can be used to inhibit the formation of gas hydrates in natural gas streams that include hydrocarbon and non-hydrocarbon mixtures, for example, in sour gas environments that include hydrogen sulfide (H₂S) and carbon dioxide (CO₂). The KHI copolymers of the present disclosure are particularly useful for preventing the formation of hydrates in light or low boiling C₁-C₅ hydrocarbons gases, non-hydrocarbon gases, or gas mixtures such as natural gas. The KHI copolymers are economically viable and biodegradable, as they can be prepared in a one-step process without using toxic acryloyl-type monomers that are typically used to produce inhibitors, in particular, those used in sour gas systems. Further, the KHI copolymers do not interfere negatively with field chemicals such as corrosion inhibitors or pipeline coating materials. As such, there exists a high potential for commercialization and field deployment due to the performance and technical feasibility of scaling-up.

The KHI copolymers of the present disclosure are particularly useful at preventing or inhibiting the formation of gas hydrates in a sour gas environment, such as in a gas composition that is rich in hydrogen sulfide (H₂S) and carbon dioxide (CO₂), which is a challenging environment in which to inhibit gas hydrate formation. The KHI copolymers are effective in such environments where high pressure and low temperature exists. The KHI copolymers of the present disclosure have a broader range of subcooling temperatures and demonstrate longer induction time periods at temperatures and pressures at which hydrate formation occurs as compared to other inhibitors used in sour gas environments.

The KHI copolymers of the present disclosure are effective at inhibiting the formation of gas hydrates that are formed due to the existence of organic molecules in the gas stream, such as methane, ethane, propane, butane, pentane, carbon dioxide, hydrogen sulfide, condensate, or mixtures thereof, that come into contact with water. In some embodiments, the amount of water in the natural gas stream is from about 0.1 wt % to about 95 wt %. The KHI copolymers of the present disclosure are effective at inhibiting the formation of gas hydrate structure types I, II, and h. Sour gases containing H₂S form mainly SI (structure I) hydrates, where methane, the most abundant molecule in natural gas fields, is the guest molecule. The KHI copolymers of the present disclosure are effective at inhibiting the formation of SI gas hydrates.

Also provided in the present disclosure are methods of inhibiting the formation of gas hydrates during the production, transportation, and processing of natural gas, such as natural gas that contains H₂S and CO₂. The methods allow for maintenance of high capacity gas production, such as during winter, when the temperature is low enough to favor gas hydrate formation.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms “sour” or “sour gas” mean that the gas stream contains hydrogen sulfide (H₂S).

The term “inhibit” is used herein generally and broadly to mean any improvement in preventing, controlling, delaying, reducing, or mitigating the formation, growth, or agglomeration of hydrocarbon hydrates in any manner, including but not limited to kinetically, thermodynamically, or by dissolution or breaking up or anti-agglomeration or a combination thereof. Although the term inhibitor is not intended to be restricted to the complete cessation of gas hydrates formation, it includes the possibility that the formation of any gas hydrate is entirely prevented.

As used herein, the term “formation” includes, but is not limited to, the formation of solid hydrates from water and hydrocarbons or hydrocarbon and non-hydrocarbons, growth, accumulation, agglomeration of hydrates or any combination thereof.

### Kinetic Hydrate Inhibitors

Provided in the present disclosure is a kinetic hydrate inhibitor (KHI) copolymer of Formula (I):

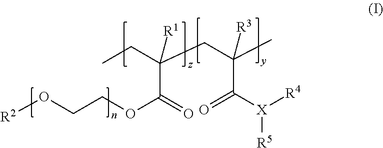

wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1,2,3, or 4; and

$$y + z = 1 ;$$

wherein the average molecular weight is from about 500 g/mol to about 10,000 g/mol; and
wherein R⁴ is absent when X is O or S.

In some embodiments, X is N. In some embodiments, X is O. In some embodiments, X is S.

In some embodiments, R¹ is H. In some embodiments, R¹ is C₁₋₆ alkyl. In some embodiments, R¹ is C₁₋₃ alkyl. In some embodiments, R¹ is hexyl. In some embodiments, R¹ is pentyl. In some embodiments, R¹ is butyl. In some embodiments, R¹ is propyl. In some embodiments, R¹ is isopropyl. In some embodiments, R¹ is ethyl. In some embodiments, R¹ is methyl. In some embodiments, R¹ is —(C₁₋₄ alkyl)OR^{a}. In some embodiments, R¹ is —(C₁₋₄ alkyl)NR^{b}R^{c}. In some embodiments, R¹ is 6-10 membered aryl. In some embodiments, R¹ is phenyl. In some embodiments, R¹ is 5-10 membered heteroaryl. In some embodiments, R¹ is —(C₁₋₄ alkyl)-6-10 membered aryl. In some embodiments, R¹ is —(C₁₋₄ alkyl)-5-10 membered heteroaryl. In some embodiments, R¹ is —C(═O)CH═CH₂.

In some embodiments, R² is H. In some embodiments, R² is C₁₋₆ alkyl. In some embodiments, R² is C₁₋₃ alkyl. In some embodiments, R² is hexyl. In some embodiments, R² is pentyl. In some embodiments, R² is butyl. In some embodiments, R² is propyl. In some embodiments, R² is isopropyl. In some embodiments, R² is ethyl. In some embodiments, R² is methyl. In some embodiments, R² is —(C₁₋₄ alkyl)OR^{a}. In some embodiments, R² is —(C₁₋₄ alkyl)NR^{b}R^{c}. In some embodiments, R² is 6-10 membered aryl. In some embodiments, R² is phenyl. In some embodiments, R² is 5-10 membered heteroaryl. In some embodiments, R² is —(C₁₋₄ alkyl)-6-10 membered aryl. In some embodiments, R² is —(C₁₋₄ alkyl)-5-10 membered heteroaryl. In some embodiments, R² is —C(═O)CH═CH₂.

In some embodiments, R³ is H. In some embodiments, R³ is C₁₋₆ alkyl. In some embodiments, R³ is C₁₋₃ alkyl. In some embodiments, R³ is hexyl. In some embodiments, R³ is pentyl. In some embodiments, R³ is butyl. In some embodiments, R³ is propyl. In some embodiments, R³ is isopropyl. In some embodiments, R³ is ethyl. In some embodiments, R³ is methyl. In some embodiments, R³ is —(C₁₋₄ alkyl)OR^{a}. In some embodiments, R³ is —(C₁₋₄ alkyl)NR^{b}R^{c}. In some embodiments, R³ is 6-10 membered aryl. In some embodiments, R³ is phenyl. In some embodiments, R³ is 5-10 membered heteroaryl. In some embodiments, R³ is —(C₁₋₄ alkyl)-6-10 membered aryl. In some embodiments, R³ is —(C₁₋₄ alkyl)-5-10 membered heteroaryl. In some embodiments, R³ is —C(═O)CH═CH₂.

In some embodiments, when X is O or S, R⁴ is absent. In some embodiments, R⁴ is H. In some embodiments, R⁴ is C₁₋₆ alkyl. In some embodiments, R⁴ is C₁₋₃ alkyl. In some embodiments, R⁴ is hexyl. In some embodiments, R⁴ is pentyl. In some embodiments, R⁴ is butyl. In some embodiments, R⁴ is propyl. In some embodiments, R⁴ is isopropyl. In some embodiments, R⁴ is ethyl. In some embodiments, R⁴ is methyl. In some embodiments, R⁴ is —(C₁₋₄ alkyl)OR^{a}. In some embodiments, R⁴ is —(C₁₋₄ alkyl)NR^{b}R^{c}. In some embodiments, R⁴ is 6-10 membered aryl. In some embodiments, R⁴ is phenyl. In some embodiments, R⁴ is 5-10 membered heteroaryl. In some embodiments, R⁴ is —(C₁₋₄ alkyl)-6-10 membered aryl. In some embodiments, R⁴ is —(C₁₋₄ alkyl)-5-10 membered heteroaryl. In some embodiments, R⁴ is —C(═O)CH═CH₂.

In some embodiments, R⁵ is H. In some embodiments, R⁵ is C₁₋₆ alkyl. In some embodiments, R⁵ is C₁₋₃ alkyl. In some embodiments, R⁵ is hexyl. In some embodiments, R⁵ is pentyl. In some embodiments, R⁵ is butyl. In some embodiments, R⁵ is propyl. In some embodiments, R⁵ is isopropyl. In some embodiments, R⁵ is ethyl. In some embodiments, R⁵ is methyl. In some embodiments, R⁵ is —(C₁₋₄ alkyl)OR^{a}. In some embodiments, R⁵ is —(C₁₋₄ alkyl)NR^{b}R^{c}. In some embodiments, R⁵ is 6-10 membered aryl. In some embodiments, R⁵ is phenyl. In some embodiments, R⁵ is 5-10 membered heteroaryl. In some embodiments, R⁵ is —(C₁₋₄ alkyl)-6-10 membered aryl. In some embodiments, R⁵ is —(C₁₋₄ alkyl)-5-10 membered heteroaryl. In some embodiments, R⁵ is —C(═O)CH═CH₂.

In some embodiments, R¹, R², R³, R⁴, and R⁵ are each independently selected from the group consisting of H and C₁₋₆ alkyl. In some embodiments, R¹, R², R³, R⁴, and R⁵ are each independently selected from the group consisting of H and C₁₋₃ alkyl.

In some embodiments, R¹ is H or methyl.

In some embodiments, R¹ is H, R² is C₁₋₃ alkyl, R³ is H, R⁴ is H, and R⁵ is C₁₋₃ alkyl. In some embodiments, R¹ is H, R² is ethyl, R³ is H, R⁴ is H, and R⁵ is isopropyl. In some embodiments, R¹ is C₁₋₃ alkyl, R² is C₁₋₃ alkyl, R³ is H, R⁴ is H, and R⁵ is C₁₋₃ alkyl. In some embodiments, R¹ is methyl, R² is ethyl, R³ is H, R⁴ is H, and R⁵ is isopropyl.

In some embodiments, n is 1 or 2. In some embodiments, n is 1. In some embodiments, n is 2. In some embodiments, n is 3. In some embodiments, n is 4.

In some embodiments, z is 0.25, 0.5, or 0.75. In some embodiments, y is 0.25, 0.5, or 0.75. In some embodiments, z is 0.25 and y is 0.75. In some embodiments, z is 0.5 and y is 0.5. In some embodiments, z is 0.75 and y is 0.25.

In some embodiments, the compound of Formula (I) has an average molecular weight of about 500 g/mol to about 10,000 g/mol, such as about 500 g/mol to about 9,000 g/mol, about 500 g/mol to about 8,000 g/mol, about 500 g/mol to about 7,000 g/mol, about 500 g/mol to about 6,000 g/mol, about 500 g/mol to about 5,000 g/mol, about 500 g/mol to about 4,000 g/mol, about 500 g/mol to about 3,000 g/mol, about 500 g/mol to about 2,000 g/mol, about 500 g/mol to about 1,000 g/mol, about 1,000 g/mol to about 10,000 g/mol, about 1,000 g/mol to about 9,000 g/mol, about 1,000 g/mol to about 8,000 g/mol, about 1,000 g/mol to about 7,000 g/mol, about 1,000 g/mol to about 6,000 g/mol, about 1,000 g/mol to about 5,000 g/mol, about 1,000 g/mol to about 4,000 g/mol, about 1,000 g/mol to about 3,000 g/mol, about 1,000 g/mol to about 2,000 g/mol, about 2,000 g/mol to about 10,000 g/mol, about 2,000 g/mol to about 9,000 g/mol, about 2,000 g/mol to about 8,000 g/mol, about 2,000 g/mol to about 7,000 g/mol, about 2,000 g/mol to about 6,000 g/mol, about 2,000 g/mol to about 5,000 g/mol, about 2,000 g/mol to about 4,000 g/mol, about 2,000 g/mol to about 3,000 g/mol, about 3,000 g/mol to about 10,000 g/mol, about 3,000 g/mol to about 9,000 g/mol, about 3,000 g/mol to about 8,000 g/mol, about 3,000 g/mol to about 7,000 g/mol, about 3,000 g/mol to about 6,000 g/mol, about 3,000 g/mol to about 5,000 g/mol, about 3,000 g/mol to about 4,000 g/mol, about 4,000 g/mol to about 10,000 g/mol, about 4,000 g/mol to about 9,000 g/mol, about 4,000 g/mol to about 8,000 g/mol, about 4,000 g/mol to about 7,000 g/mol, about 4,000 g/mol to about 6,000 g/mol, about 4,000 g/mol to about 5,000 g/mol, about 5,000 g/mol to about 10,000 g/mol, about 5,000 g/mol to about 9,000 g/mol, about 5,000 g/mol to about 8,000 g/mol, about 5,000 g/mol to about 7,000 g/mol, about 5,000 g/mol to about 6,000 g/mol, about 6,000 g/mol to about 10,000 g/mol, about 6,000 g/mol to about 9,000 g/mol, about 6,000 g/mol to about 8,000 g/mol, about 6,000 g/mol to about 7,000 g/mol, about 7,000 g/mol to about 10,000 g/mol, about 7,000 g/mol to about 9,000 g/mol, about 7,000 g/mol to about 8,000 g/mol, about 8,000 g/mol to about 10,000 g/mol, about 8,000 g/mol to about 9,000 g/mol, about 9,000 g/mol to about 10,000 g/mol, or about 500 g/mol, about 1,000 g/mol, about 2,000 g/mol, about 3,000 g/mol, about 4,000 g/mol, about 5,000 g/mol, about 6,000 g/mol, about 7,000 g/mol, about 8,000 g/mol, about 9,000 g/mol, or about 10,000 g/mol. In some embodiments, the compound of Formula (I) has an average molecular weight of about 500 g/mol to about 5,000 g/mol. In some embodiments, the compound of Formula (I) has an average molecular weight of is about 800 g/mol to about 2,000 g/mol. In some embodiments, the compound of Formula (I) has an average molecular weight of about 1,000 g/mol to about 3,500 g/mol. In some embodiments, the average molecular weight is determined by electrospray ionization (ESI). In some embodiments, the average molecular weight is determined by gel permeation chromatography (GPC).

In some embodiments, the compound is a compound of Formula (Ia):

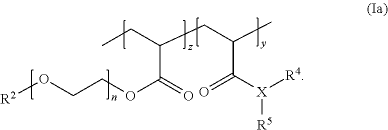

In some embodiments, the compound is a compound of Formula (Ib):

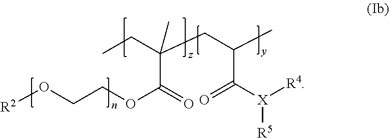

In some embodiments, the compound is a compound of Formula (Ic):

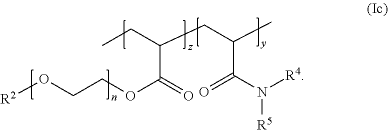

In some embodiments, the compound is a compound of Formula (Id):

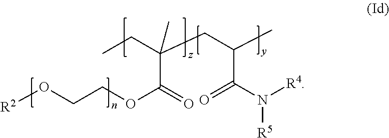

In some embodiments, the compound is selected from the group consisting of:

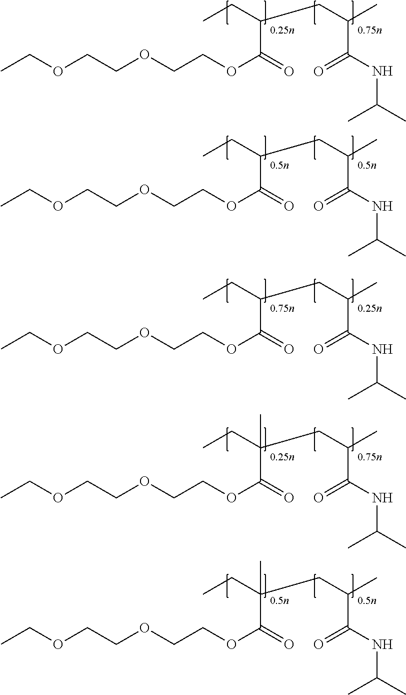

Also provided in the present disclosure are formulations or compositions containing the KHI copolymer of Formula (I) and one or more solvents, one or more additives, one or more synergists, and combinations thereof. In some embodiments, the solvent is selected from an alcohol, an ether, a glycol, or combinations thereof. In some embodiments, the compositions include polyethylene oxide.

Provided in the present disclosure is a method of preparing a KHI copolymer of the present disclosure. The method is a one-step polymerization process. In some embodiments, the method includes reacting N-isopropyl acrylamide (NIPAM) with a monomer selected from 2-di(ethylene glycol) ethyl ether acrylate (DEGA) and ethoxyethyl methacrylate (EEM) in the presence of an azo initiator and a chain transfer agent; and forming the KHI copolymer.

In some embodiments, the monomer is DEGA. In some embodiments, the monomer is EEM.

In some embodiments of the method, the NIPAM and DEGA are reacted at a ratio of 3:1 to 1:3, such as 3:1, 2:1, 1:1, 1:2, or 1:3. In some embodiments, the NIPAM and DEGA are reacted at a ratio of 3:1. In some embodiments, the NIPAM and DEGA are reacted at a ratio of 2:1. In some embodiments, the NIPAM and DEGA are reacted at a ratio of 1:1. In some embodiments, the NIPAM and DEGA are reacted at a ratio of 1:2. In some embodiments, the NIPAM and DEGA are reacted at a ratio of 1:3.

In some embodiments of the method, the NIPAM and EEM are reacted at a ratio of 3:1 to 1:3, such as 3:1, 2:1, 1:1, 1:2, or 1:3. In some embodiments, the NIPAM and EEM are reacted at a ratio of 3:1. In some embodiments, the NIPAM and EEM are reacted at a ratio of 2:1. In some embodiments, the NIPAM and EEM are reacted at a ratio of 1:1. In some embodiments, the NIPAM and EEM are reacted at a ratio of 1:2. In some embodiments, the NIPAM and EEM are reacted at a ratio of 1:3.

Examples of suitable azo initiators include, but are not limited to azoisobutyronitrile, 4,4′-azobis(4-cyanovaleric acid), 1,1′-azobis(cyclohexanecarbonitrile), 2,2′-azobis(2-methylpropionamidine) dihydrochloride, 2,2′-azobis(2-methylpropionitrile), 2,2′-azobis(2-methylpropionitrile), 2,2′-azobisisoheptonitrile, and 2,2′-azobis[2-(2-imidazolin-2-yl)propane]dihydrochloride. In some embodiments, the azo initiator is 4,4′-azobis(4-cyanovaleric acid).

Examples of suitable chain transfer agents include, but are not limited to, thioglycolic acid, methyl thioglycolate, esters of thioglycolic acid, mercaptopropionic acid, such as 3-mercaptopropionic acid, 2-mercaptopropionic acid, and methyl 3-mercaptoprioponate, esters of mercaptopropionic acid, mercaptobutanoic acid, such as 4-mercapto-n-butanoic acid, and esters of mercaptobutanoic acid. In some embodiments, the chain transfer agent is thioglycolic acid.

In some embodiments of the method, the NIPAM and DEGA or EEM are reacted in a solvent. In some embodiments, the solvent is water. In some embodiments, the solvent is deionized water.

In some embodiments, the method further includes heating the reaction mixture. In some embodiments, the reaction mixture is heated to about 60° C. to about 100° C., for example, about 60° C. to about 90° C., about 60° C. to about 80° C., about 60° C. to about 70° C., about 60° C. to about 65° C., about 65° C. to about 100° C., about 65° C. to about 90° C., about 65° C. to about 80° C., about 65° C. to about 70° C., about 70° C. to about 100° C., about 70° C. to about 90° C., about 70° C. to about 80° C., about 80° C. to about 100° C., about 80° C. to about 90° C., about 90° C. to about 100° C., or about 60° C., about 65° C., about 70° C., about 75° C., about 80° C., about 85° C., about 90° C., about 95° C., or about 100° C. In some embodiments, the reaction mixture is heated to about 60° C.-65° C. In some embodiments, the reaction mixture is heated to about 63° C. The reaction mixture can be heated for about one hour to about 15 hours. In some embodiments, the reaction mixture is heated overnight.

In some embodiments, the KHI copolymers produced by the method of the present disclosure are substantially soluble in water. In some embodiments, the KHI copolymers produced by the method of the present disclosure are not substantially soluble in water. In some embodiments, the KHI copolymers produced by the method of the present disclosure are soluble in organic solvents, including, but not limited to, alcohols, such as methanol, monoethylene glycol (MEG), diethylene glycol monoethyl ether (DGME), 2-butoxyethanol, ketonic solvents, aromatic solvents, and aromatic naphthas, such as toluene.

### Methods of Inhibiting Gas Hydrate Formation

Provided in the present disclosure are methods of preventing or inhibiting the formation of gas hydrates in a natural gas stream. In some embodiments, the natural gas stream contains hydrogen sulfide and carbon dioxide, gas condensate (a mixture of low-boiling hydrocarbons), and combinations thereof. In some embodiments, the natural gas stream does not contain one or more of hydrogen sulfide, carbon dioxide, or gas condensate. In some embodiments, the method is useful for preventing or inhibiting the formation of gas hydrates in a sour gas environment.

In some embodiments, KHIs are included in about 0.5 wt % to about 2.5 wt % of an aqueous composition, and thus provide a lower energy footprint and lower emissions compared to other methods of inhibiting gas hydrate formation, such as MEG, with regeneration by boiling, electrical heating, or thermodynamic inhibitors, which typically require dosages up to about 25 wt % to about 50 wt %.

In some embodiments, the method includes adding a composition that contains a kinetic hydrate inhibitor (KHI) copolymer of Formula (I) of the present disclosure to a natural gas stream, thereby inhibiting the formation of gas hydrates in the natural gas.

In some embodiments of the method, the composition includes a solvent. In some embodiments, the solvent is selected from an alcohol, an ether, a glycol, or combinations thereof. In some embodiments, the composition includes additives or synergists. In some embodiments, the solvents, additives, or synergists improve the inhibition of the gas hydrates. In some embodiments, the compositions include polyethylene oxide.

In some embodiments, the composition includes about 10 wt % to about 60 wt % of the KHI copolymer of Formula (I), such as about 10 wt % to about 55 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, is about 10 wt % to about 15 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 60 wt %, about 20 wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 wt % to about 60 wt %, about 25 wt % to about 55 wt %, about 25 wt % to about 50 wt %, about 25 wt % to about 45 wt %, about 25 wt % to about 40 wt %, about 25 wt %, to about 40 wt %, about 25 wt % to about 35 wt %, about 25 wt % to about 30 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 40 wt %, about 30 wt % to about 35 wt %, about 35 wt % to about 60 wt %, about 35 wt % to about 55 wt %, about 35 wt % to about 50 wt %, about 35 wt % to about 45 wt %, about 35 wt % to about 40 wt %, about 35 wt % to about 40 wt %, about 40 wt % to about 60 wt %, about 40 wt % to about 55 wt %, about 40 wt % to about 50 wt %, about 40 wt % to about 45 wt %, about 45 wt % to about 60 wt %, about 45 wt % to about 55 wt %, about 45 wt % to about 50 wt %, about 50 wt % to about 60 wt %, about 50 wt % to about 55 wt %, about 55 wt % to about 60 wt %, or about 10 wt %, about 15 wt %, about 20 wt %, about 25 wt %, about 30 wt %, about 35 wt %, about 40 wt %, about 45 wt %, about 50 wt %, about 55 wt %, or about 60 wt %. In some embodiments, the composition includes about 30 wt % of the KHI copolymer of Formula (I).

In some embodiments of the method, the KHI copolymer of Formula (I) is added to the natural gas stream in an amount of about 0.25 wt % to about 15 wt %, such as about 0.25 wt % to about 10 wt %, about 0.25 wt % to about 9 wt %, about 0.25 wt % to about 8 wt %, about 0.25 wt % to about 7 wt %, about 0.25 wt % to about 6 wt %, about 0.25 wt % to about 5 wt %, about 0.25 wt % to about 4 wt %, about 0.25 wt % to about 3 wt %, about 0.25 wt % to about 2 wt %, about 0.25 wt % to about 1 wt %, about 1 wt % to about 15 wt %, about 1 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 1 wt % to about 2 wt %, about 2 wt % to about 15 wt %, about 2 wt % to about 10 wt %, about 2 wt % to about 9 wt %, about 2 wt % to about 8 wt %, about 2 wt % to about 7 wt %, about 2 wt % to about 6 wt %, about 2 wt % to about 5 wt %, about 2 wt % to about 4 wt %, about 2 wt % to about 3 wt %, about 3 wt % to about 15 wt %, about 3 wt % to about 10 wt %, about 3 wt % to about 9 wt %, about 3 wt % to about 8 wt %, about 3 wt % to about 7 wt %, about 3 wt % to about 6 wt %, about 3 wt % to about 5 wt %, about 3 wt % to about 4 wt %, about 4 wt % to about 15 wt %, about 4 wt % to about 10 wt %, about 4 wt % to about 9 wt %, about 4 wt % to about 8 wt %, about 4 wt % to about 7 wt %, about 4 wt % to about 6 wt %, about 4 wt % to about 5 wt %, about 5 wt % to about 15 wt %, about 5 wt % to about 10 wt %, about 5 wt % to about 9 wt %, about 5 wt % to about 8 wt %, about 5 wt % to about 7 wt %, about 5 wt % to about 6 wt %, about 6 wt % to about 15 wt %, about 6 wt % to about 10 wt %, about 6 wt % to about 9 wt %, about 6 wt % to about 8 wt %, about 6 wt % to about 7 wt %, about 7 wt % to about 15 wt %, about 7 wt % to about 10 wt %, about 7 wt % to about 9 wt %, about 7 wt % to about 8 wt %, about 8 wt % to about 15 wt %, about 8 wt % to about 10 wt %, about 8 wt % to about 9 wt %, about 9 wt % to about 15 wt %, about 9 wt % to about 10 wt %, or about 0.25 wt %, about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. In some embodiments of the method, the KHI copolymer of Formula (I) is added to the natural gas stream in an amount of about 3 wt %.

In some embodiments, the KHI copolymers used in the methods of the present disclosure are effective at inhibiting the formation of gas hydrates in a wide variety of gas fields where conditions and operational parameters vary from gas field to gas field, including, but not limited to, variations in temperature, pressure, stream chemicals composition, and the presence of additives. In some embodiments of the method, the KHI copolymers of the present disclosure are compatible with other additives that may be present in the gas field, including, but not limited to, corrosion inhibitors or pipeline coating materials.

In some embodiments of the method, the composition inhibits gas hydrate formation at a pressure of about 20 bars to about 200 bars, such as about 20 bars to about 180 bars, about 20 bars to about 160 bars, about 20 bars to about 140 bars, about 20 bars to about 120 bars, about 20 bars to about 100 bars, about 20 bars to about 80 bars, about 20 bars to about 60 bars, about 20 bars to about 40 bars, about 40 bars to about 200 bars, about 40 bars to about 180 bars, about 40 bars to about 160 bars, about 40 bars to about 140 bars, about 40 bars to about 120 bars, about 40 bars to about 100 bars, about 40 bars to about 80 bars, about 40 bars to about 60 bars, about 60 bars to about 200 bars, about 60 bars to about 180 bars, about 60 bars to about 160 bars, about 60 bars to about 140 bars, about 60 bars to about 120 bars, about 60 bars to about 100 bars, about 60 bars to is about 80 bars, about 80 bars to about 200 bars, about 80 bars to about 180 bars, about 80 bars to about 160 bars, about 80 bars to about 140 bars, about 80 bars to about 120 bars, about 80 bars to about 100 bars, about 100 bars to about 200 bars, about 100 bars to about 180 bars, about 100 bars to about 160 bars, about 100 bars to about 140 bars, about 100 bars to about 120 bars, about 120 bars to about 200 bars, about 120 bars to about 180 bars, about 120 bars to about 160 bars, about 120 bars to about 140 bars, about 140 bars to about 200 bars, about 140 bars to about 180 bars, about 140 bars to about 160 bars, about 160 bars to about 200 bars, about 160 bars to about 180 bars, about 180 bars to about 200 bars, or about 20 bars, about 40 bars, about 60 bars, about 80 bars, about 100 bars, about 120 bars, about 140 bars, about 160 bars, about 180 bars, or about 200 bars. In some embodiments, the composition inhibits gas hydrate formation at a pressure of about 20 bars to about 160 bars. In some embodiments, the composition inhibits gas hydrate formation at a pressure of about 40 bars to about 200 bars.

In some embodiments of the method, the composition inhibits gas hydrate formation at a temperature of about 0° C. to about 20° C., such as about 0° C. to about 15° C., about 0° C. to about 10° C., about 0° C. to about 5° C., about 5° C. to about 20° C., about 5° C. to about 15° C., about 5° C. to about 10° C., about 10° C. to about 20° C., about 10° C. to about 15° C., about 15° C. to about 20° C., or about 0° C., about 5° C., about 10° C., about 15° C., or about 20° C. In some embodiments of the method, the addition of the KHI copolymer allows for a wider range of subcooling temperatures as compared to other kinetic hydrate inhibitors.

In some embodiments, the method prevents the formation of hydrates. In some embodiments, the method prevents the formation of hydrates for at least about 2 hours, at least about 4 hours, at least about 8 hours, at least about 9 hours, at least about 10 hours, at least about 11 hours, at least about 12 hours, at least about 15 hours, at least about 19 hours, at least about 24 hours, at least about 28 hours, at least about 36 hours, at least about 44 hours, at least about 48 hours, at least about 50 hours, at least about 58 hours, at least about 86 hours, or longer.

### EXAMPLES

### Example 1—Preparation of Copolymers

Materials used: N-isopropyl acrylamide (NIPAM), ethoxyethyl methacrylate (EEM) and ethanol were purchased from Sigma-Aldrich (St. Louis, MO). 2-Di(ethylene glycol) ethyl ether acrylate (DEGA) was purchased from TCI (Portland, OR). 4,4-Azobis(4-cyanovaleric acid) was purchased from Alfa Aesar (Haverhill, MA). Thioglycolic acid was purchased from Spectrum Chemical Mfg. Corp. (New Brunswick, NJ).

Five different KHI copolymers (KHI-1 to KHI-5) were prepared as shown in Scheme 1.

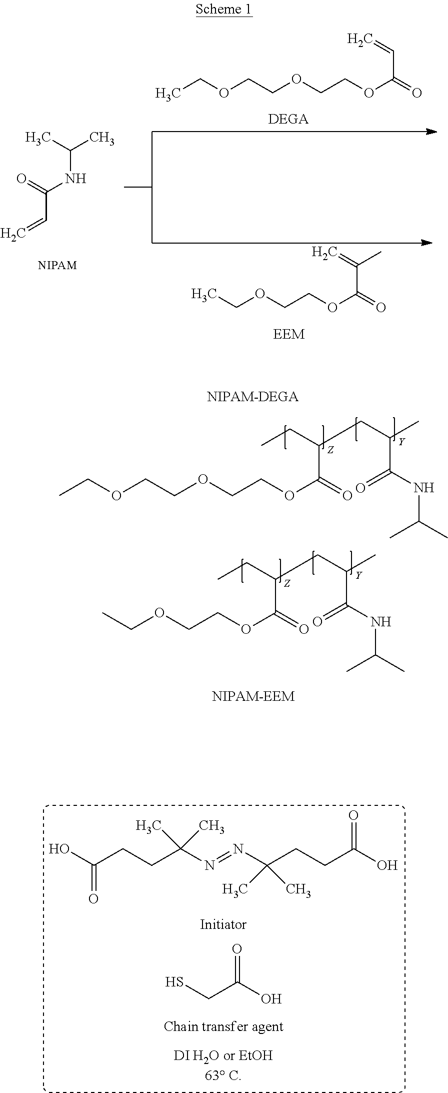

Briefly, KHI-1 was synthesized by adding 4,4-azobis(4-cyanovaleric acid) initiator (0.11 g, 0.39 mmol) to a solution of the monomers NIPAM (1.968 g, 17.4 mmol) and DEGA (1.091 g, 5.8 mmol), and the chain transfer agent thioglycolic acid (0.208 g, 2.258 mmol) in DI water (2 g, 111 mmol). The reaction mixture was then heated overnight at 63° C.

KHI-4 was synthesized by adding 4,4-azobis(4-cyanovaleric acid) initiator (0.11 g, 0.39 mmol) to a solution of the monomers NIPAM (1.968 g, 17.4 mmol) and EEM (0.917 g, 5.8 mmol), and the chain transfer agent thioglycolic acid (0.32 g, 3.475 mmol) in DI water (2 g, 111 mmol). The reaction mixture was then heated overnight at 63° C.

KHI-2, KHI-3, and KHI-5 were synthesized according to the same procedure used to synthesize KHI-4, but by adjusting the amount of thioglycolic acid to adjust the molecular weight of the copolymer and by using different ratios of monomers.

The structures and ratio of monomers of the KHI copolymers is shown in Table 1.

TABLE 1

| | | |
|---|---|---|
| KHI | Ratio of | |
| copolymer | monomers | Structure |

NIPAM-DEGA

| | | |
|---|---|---|
| KHI-1 | 75:25 | 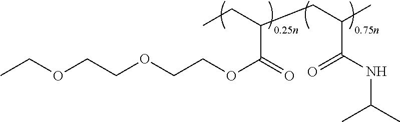 |
| KHI-2 | 50:50 | 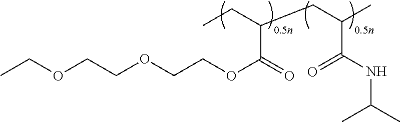 |
| KHI-3 | 25:75 | 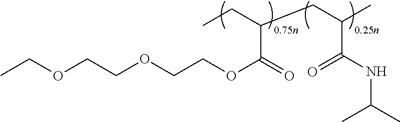 |

NIPAM-EEM

| | | |
|---|---|---|
| KHI-4 | 75:25 | 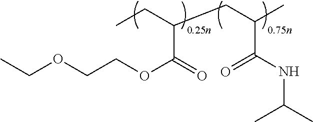 |
| KHI-5 | 50:50 | 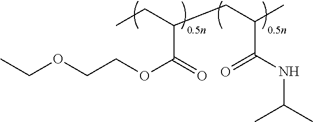 |

### Example 2—Characterization of the KHI Copolymers

### Nuclear Magnetic Resonance (NMR) Spectroscopy

The synthesized polymers KHI-1 to KHI-5 were characterized using ¹H and/or ¹³C{¹H} NMR spectroscopy. A JEOL 500 MHz NMR spectrometer was utilized to obtain spectra using appropriate acquisition parameters. The analyses of the ¹H and ¹³C{¹H}NMR spectra were carried out in deuterated dimethylsulfoxide (DMSO-d₆), and the chemical shifts were set to those of the solvent (2.5 ppm and 39.52 ppm for ¹H and ¹³C{¹H}, respectively).

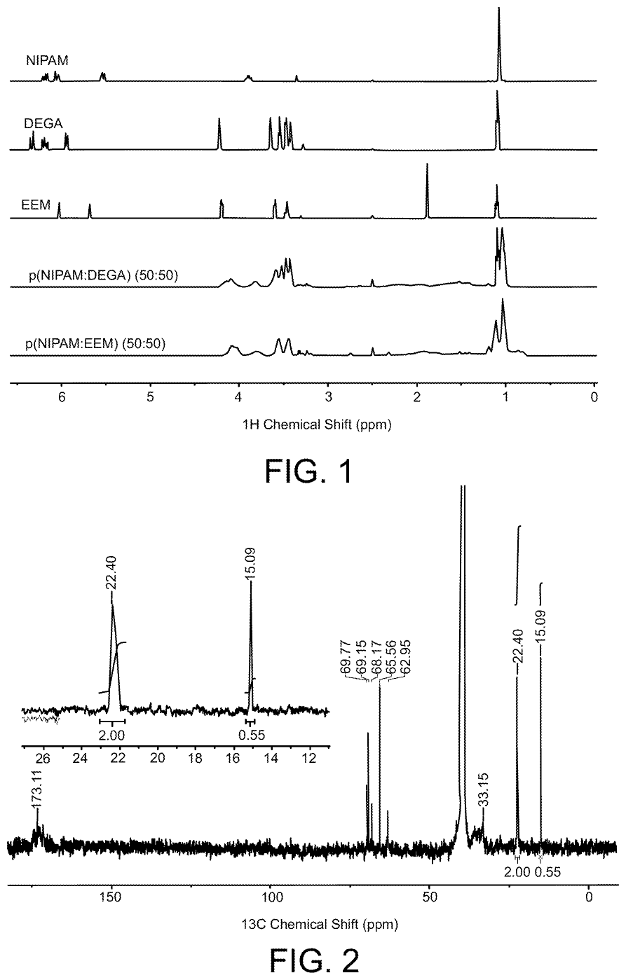

FIG. 1 shows the ¹H NMR spectra of the monomers NIPAM, DEGA, and EEM, and the synthesized KHI copolymers KHI-2 and KHI-5. The typical peaks of the vinyl groups of the monomers would be present in the region of 5.5-7 ppm. After polymerization of NIPAM with either DEGA or EEM, the ¹H spectra showed a loss of monomer vinyl groups, and produced two peaks at 1.04 ppm and 1.09 ppm, which were assigned to the methyl groups of NIPAM and DEGA/EEM, respectively. These peaks were used to determine the incorporation of NIPAM and DEGA/EEM in the polymer.

Due to the overlap of the ¹H NMR peaks of NIPAM and DEGA/EEM, quantitative ¹³C{¹H}NMR spectroscopy was employed to check the accuracy of the molar incorporation calculated via the former. FIG. 2 shows the quantitative ¹³C{¹H}NMR spectrum of KHI-1. Distinct, well-separated peaks of NIPAM (22.40 ppm) and DEGA (15.09 ppm) were observed in the spectrum, which could be used to establish molar incorporation of the respective repeat units in the polymer. Relative to the molar ratios determined by ¹H NMR, a difference of up to ˜5% was observed. Hence, due to a relatively low error and fast spectral acquisition, ¹H NMR spectroscopy was used exclusively to determine the incorporation levels of NIPAM and DEGA/EEM in all of the synthesized KHI copolymers.

### ESI-MS Analysis

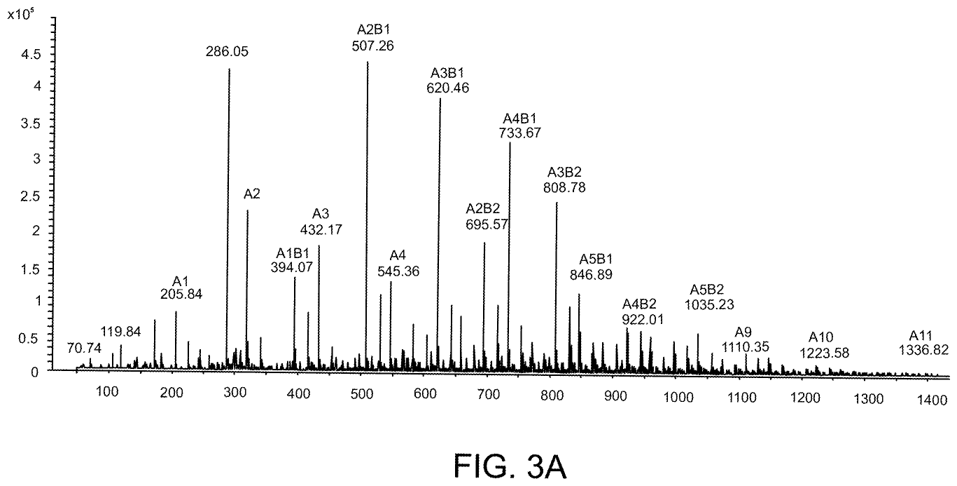

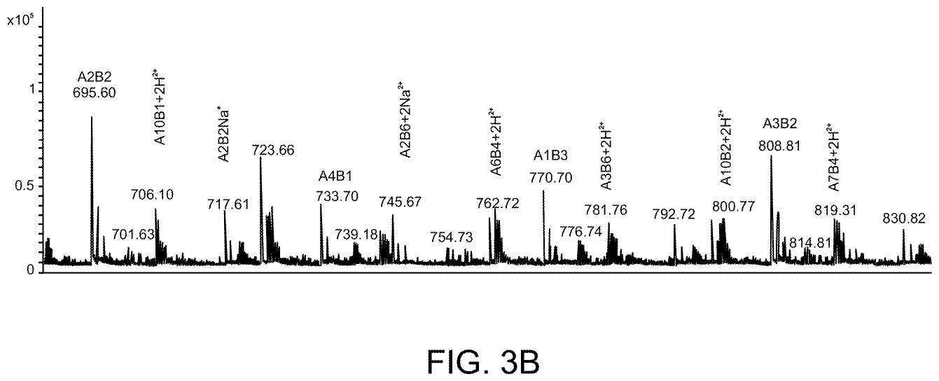

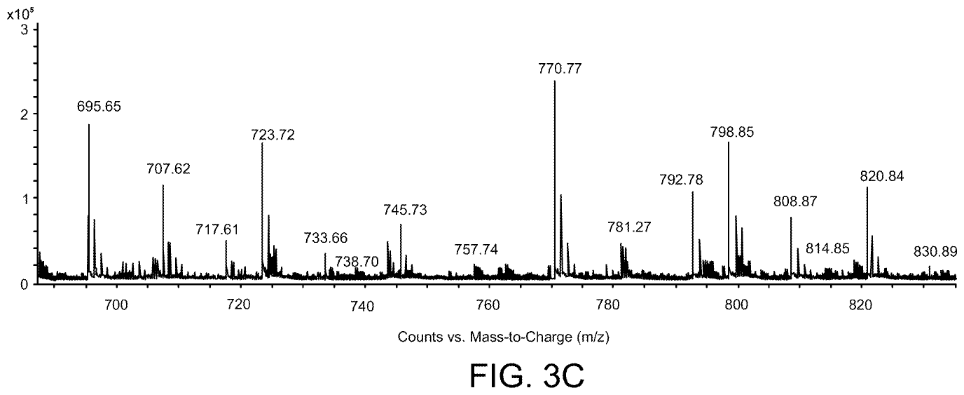

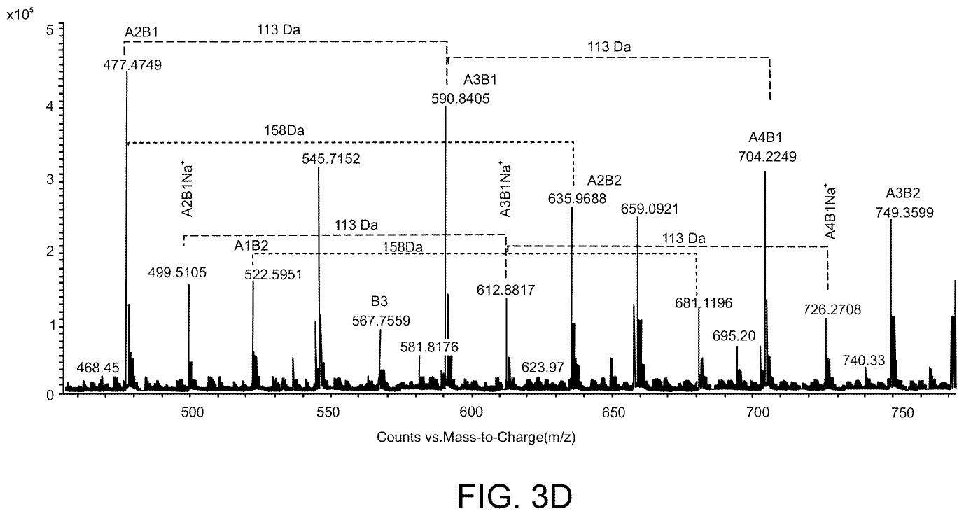

The synthesized KHI copolymers were characterized using mass spectra (6320 TOF MS (Agilent Technologies, USA), equipped with an electrospray ionization (ESI) source, operated in the positive mode, and Mass Hunter workstation software (Agilent Technologies, USA)). The samples were dissolved in MeOH (Chromasolv grade, Sigma Aldrich). The samples were delivered by a syringe pump at a flow rate of 120 L/h. ESI-MS analysis of all synthesized KHI copolymers indicated successful synthesis. FIGS. 3A-3D show the mass spectra of the KHI copolymers and the successful incorporation of the monomers for KHI-1 (FIG. 3A), KHI-2 (FIG. 3B), and KHI-3 (FIG. 3C), where A: NIPAM, Mw=113.16 and B: DEGA, Mw=188.22; and KHI-4 (FIG. 3D), where A: NIPAM, Mw=113.16 and B: EEM, Mw=158.19.

### GPC Analysis

The molecular weight distribution profiles of the four KHI copolymers (KHI-1 to KHI-4) were determined using gel permeation chromatograph. The weight average molecular weight (Mw) and the polydispersity index (PDI) values of the analyzed KHI copolymers were calculated and are shown in Table 2.

TABLE 2
Molecular weight distribution profiles

| | Feed | Feed ratio of | | | |
|---|---|---|---|---|---|
| | ratio of | monomers | MW _{GPC} | | MW _{ESI} |
| Copolymer | monomers | (¹H NMR) | (g mol⁻¹) | PDI _{GPC} | (g mol⁻¹) |
| KHI-1 | 25:75 | 30:70 | 3151 | 4.67 | 921 |
| KHI-2 | 50:50 | 51:49 | 2804 | 2.5 | 1852 |
| KHI-3 | 75:25 | 74:26 | 1286 | 1.7 | 1861 |
| KHI-4 | 25:75 | 28:72 | 1607 | 3.63 | 824 |
| KHI-5 | 50:50 | 49:51 | 1166 | 1.7 | — |

### Example 3—Evaluation of the KHI Copolymers in a Real Gas Set-Up

The synthesized KHI copolymers were evaluated in a real gas set up “rocking cells (RC-5).” The RC-5 consisted of five Hastelloy cells capable of operating under high pressure (maximum 200 bars) and sour gas conditions. The Hastelloy cells were immersed in one temperature-controlled bath containing ethylene glycol and water. During operation, the RC-5 was rocked to ensure that the fluid slurry was well-mixed. The RC-5 enabled the formation of natural gas clathrate hydrates under simulated operating conditions to test KHI effectiveness. Data acquisition was completed with software to enable measurement of the pressure and temperature with time in each of the Hastelloy cells. Table 3 summarizes the applied testing protocol.

TABLE 3
Programmed temperature stages in the RC-5

| | Start Temp | Average Ramp | T_{sc} | Duration |
|---|---|---|---|---|
| Stage | (° C.) | (° C./min) | (° C./min) | (hrs) |
| S-1 | 13.0 | 0.1 | 5.6 | 24-48 |
| S-2 | 12.0 | 0.05 | 6.6 | 12-24 |
| S-3 | 11.0 | 0.05 | 7.6 | 12-24 |
| S-4 | 10.0 | 0.05 | 8.6 | 12-24 |

To simulate the natural gas pipeline field operating conditions, a brine and natural gas were specially prepared and mixed. The brine was an aqueous solution of sodium chloride, acetic acid, and formic acid (along with conjugate bases) having the composition shown in Table 4. Field natural gas contains primarily methane, carbon dioxide, hydrogen sulfide, and nitrogen with small amounts of ethane, propane, and butane having the composition shown in Table 3. The polymers were evaluated in the form of a formulation in monoethylene glycol (MEG) using the RC-5 technique.

TABLE 4
Brine water composition

| Component | Concentration (mg/L) |
|---|---|
| Chloride (Cl⁻) | 607 |
| Sodium (Na⁺) | 393 |
| Acetic Acid (CH₃COOH) | 500 |
| Formic Acid (HCOOH) | 250 |

The performance of the KHI copolymers was evaluated at 300 dosage at 140 bars using the gas composition shown in Table 5.

TABLE 5
Field gas composition

| Component | Mol % |
|---|---|
| Methane (CH₄) | 60-90 |
| Ethane (C₂H₆) | 0-4 |
| Propane (C₃H₈) | 0-1 |
| Butane (C₄H₁₀) | 0-1 |
| Carbon dioxide (CO₂) | 0-15 |
| Hydrogen sulfide (H₂S) | 0-5 |
| Nitrogen (N₂) | 0-15 |

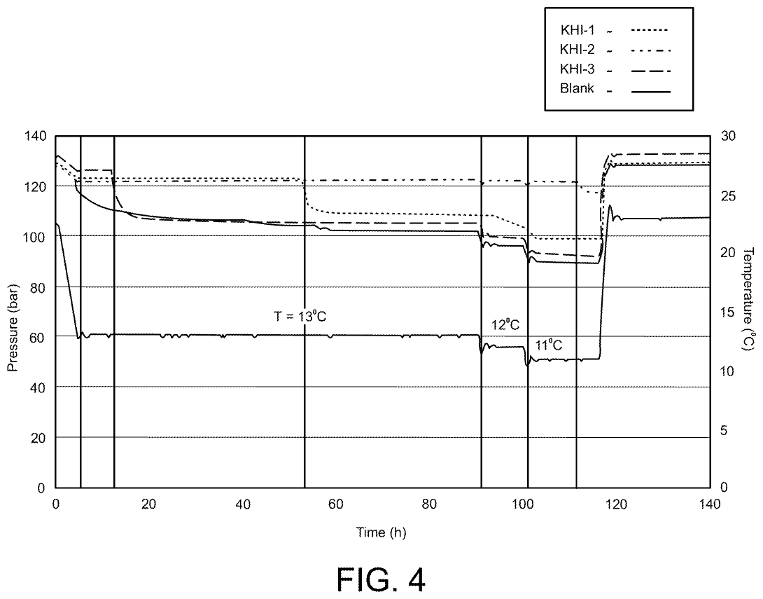

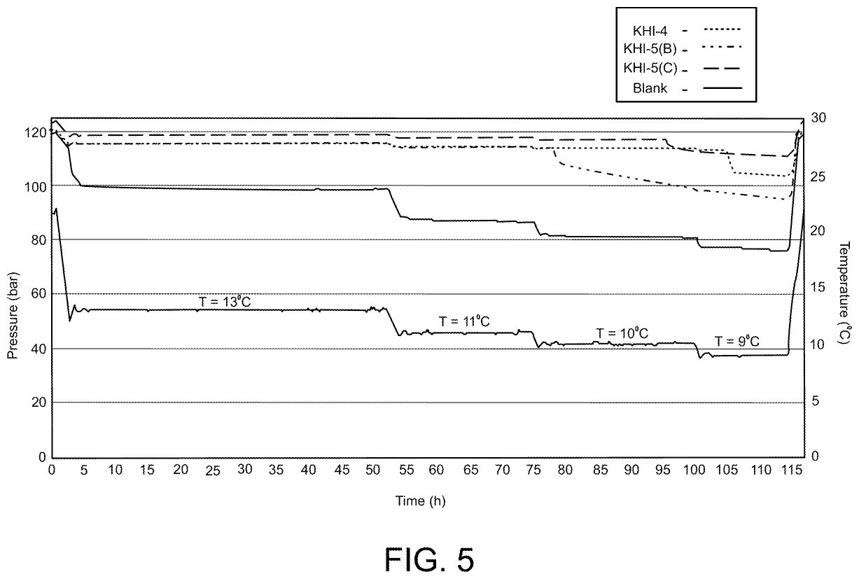

In general, KHI-1, KHI-2, KHI-4, and KHI-5 copolymers showed excellent performance in preventing gas hydrate formation for almost more than 40 hours at a subcooling of 5.6° C. Furthermore, KHI-4 and KHI-5 showed no gas hydrate formation at a high subcooling of 8.6° C. The hydrophobic/hydrophilic ratio and the solvent system have a significant impact on the performance of the KHIs. The results are summarized in Tables 6 and 7 and depicted in FIGS. 4 and 5.

TABLE 6
Performance of the KHI copolymers with 3% corrosion inhibitor at 140 bars

| | | | | Hydrate onset time (hr) | | |
|---|---|---|---|---|---|---|
| | | | | T = 13° C. | T = 12° C. | T = 11° C. |
| | Composition | | | (Sub- | (Sub- | (Sub- |
| | Solvent | KHI | Total | cooling | cooling | cooling |
| Copolymer | (wt. %) | (wt. %) | solvent | 5.6° C.) | 6.6° C.) | 7.6° C.) |
| KHI-1 | Diethylene glycol | 30% | 70% | No hydrate | Hydrate | Hydrate |
| | monoethyl ether (10%) | | | formation | | |
| | Naphtha (15%) | | | for ≈ 58 h | | |
| KHI-2 | 1-Octanol (45%) | | | No hydrate | No hydrate | No hydrate |
| | | | | formation | | formation |
| | | | | for ≈ 86 h | | for ≈ 9 h |
| KHI-3 | | | | No hydrate | Hydrate | Hydrate |
| | | | | formation | | |
| | | | | for ≈ 12 h | | |

| | | | | |
|---|---|---|---|---|
| Blank | No KHI | Hydrate | Hydrate | Hydrate |

TABLE 7
Performance of the KHI copolymers with 3% corrosion inhibitor

| | | | | Hydrate onset time (hr) | | | |
|---|---|---|---|---|---|---|---|
| | | | | T = 13° C. | T = 11° C. | T = 10° C. | T = 9° C. |
| | Composition | | | (Sub- | (Sub- | (Sub- | (Sub- |
| | Solvent | KHI | Total | cooling | cooling | cooling | cooling |
| Copolymer | (wt. %) | (wt. %) | solvent | 5.6° C.) | 7.6° C.) | 8.6° C.) | 9.6° C.) |
| KHI-4 | DGME (10%) | 30% | 70% | No | No | No | — |
| | Naphtha (30%) | | | hydrate | hydrate | hydrate | |
| | 1-Octanol (30%) | | | formation | formation | formation | |
| | | | | for ≈ 44 h | for ≈ 24 h | for ≈ 11 h | |
| KHI-4 (A) | DGME (10%) | 30% | 70% | No | No | No | No |
| | Naphtha (40%) | | | hydrate | hydrate | hydrate | hydrate |
| | 1-Octanol (20%) | | | formation | formation | formation | formation |
| | | | | for ≈ 50 h | for ≈ 19 h | for ≈ 28 h | for ≥ 4 h |
| KHI-5 (B) | DGME (10%) | 30% | 70% | No | No | No | Hydrate |
| | Naphtha (30%) | | | hydrate | hydrate | hydrate | |
| | 1-Octanol (30%) | | | formation | formation | formation | |
| | | | | for ≈ 50 h | for ≈ 19 h | for ≈ 2 h | |
| KHI-5 (C) | DGME (10%) | 30% | 70% | No | No | No | Hydrate |
| | Naphtha (40%) | | | hydrate | hydrate | hydrate | |
| | 1-Octanol (20%) | | | formation | formation | formation | |
| | | | | for ≈ 50 h | for ≈ 19 h | for ≈ 15 h | |

| | | | | | |
|---|---|---|---|---|---|
| Blank | No KHI | Hydrate | Hydrate | Hydrate | Hydrate |

### Embodiments

Embodiment 1. A kinetic hydrate inhibitor (KHI) copolymer of Formula (I):

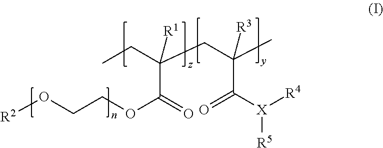

wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and

$$y + z = 1 ;$$

wherein the average molecular weight is from about 500 g/mol to about 10,000 g/mol; and
wherein R⁴ is absent when X is O or S.
   Embodiment 2. The compound of embodiment 1, wherein X is N.
   Embodiment 3. The compound of embodiment 1 or 2, wherein R¹, R², R³, R⁴, and R⁵ are each independently selected from the group consisting of H and C₁₋₆ alkyl.
   Embodiment 4. The compound of any one of embodiments 1-3, wherein R¹ is H.
   Embodiment 5. The compound of any one of embodiments 1-3, wherein R¹ is C₁₋₆ alkyl.
   Embodiment 6. The compound of any one of embodiments 1-5, wherein R² is C₁₋₆ alkyl.
   Embodiment 7. The compound of any one of embodiments 1-6, wherein R³ is H.
   Embodiment 8. The compound of any one of embodiments 1-6, wherein R⁴ is H.
   Embodiment 9. The compound of any one of embodiments 1-8, wherein R⁵ is C₁₋₆ alkyl.
   Embodiment 10. The compound of any one of embodiments 1-9, wherein n is 1 or 2.
   Embodiment 11. The compound of any one of embodiments 1-10, wherein z is 0.25, 0.5, or 0.75.
   Embodiment 12. The compound of any one of embodiments 1-11, wherein the average molecular weight is from about 500 g/mol to about 5,000 g/mol.
   Embodiment 13. The compound of embodiment 1, wherein:
X is N;
R¹ is H or C₁₋₆ alkyl;
R² is C₁₋₆ alkyl;
R³ is H;
R⁴ is H
R⁵ is C₁₋₆ alkyl; and
n is 1 or 2.
   Embodiment 14. The compound of embodiment 13, wherein R¹ is ethyl or methyl.
   Embodiment 15. The compound of embodiment 13 or 14, wherein R² is ethyl.
   Embodiment 16. The compound of any one of embodiments 13-15, wherein R⁵ is isopropyl.
   Embodiment 17. A method of preparing a KHI copolymer of any one of embodiments 1-16, comprising:
reacting N-isopropyl acrylamide (NIPAM) with a monomer selected from 2-di(ethylene glycol) ethyl ether acrylate (DEGA) and ethoxyethyl methacrylate (EEM) in the presence of an azo initiator and a chain transfer agent; and
forming the KHI copolymer.
   Embodiment 18. The method of embodiment 17, wherein the monomer is DEGA.
   Embodiment 19. The method of embodiment 17 or 18, wherein the monomer is EEM.
   Embodiment 20. The method of any one of embodiments 17-19, wherein the azo initiator is selected from the group consisting of azoisobutyronitrile, 4,4′-azobis(4-cyanovaleric acid), 1,1′-azobis(cyclohexanecarbonitrile), 2,2′-azobis(2-methylpropionamidine) dihydrochloride, 2,2′-azobis(2-methylpropionitrile), 2,2′-azobis(2-methylpropionitrile), 2,2′-azobisisoheptonitrile, and 2,2′-azobis[2-(2-imidazolin-2-yl)propane]dihydrochloride.
   Embodiment 21. The method of any one of embodiments 17-20, wherein the azo initiator is 4,4′-azobis(4-cyanovaleric acid).
   Embodiment 22. The method of any one of embodiments 17-21, wherein the chain transfer agent is selected from the group consisting of thioglycolic acid, esters of thioglycolic acid, mercaptopropionic acid, esters of mercaptopropionic acid, mercaptobutanoic acid, and esters of mercaptobutanoic acid.
   Embodiment 23. The method of any one of embodiments 17-22, wherein the chain transfer agent is thioglycolic acid.
   Embodiment 24. A method of inhibiting the formation of gas hydrates in natural gas, comprising:
adding a composition comprising a kinetic hydrate inhibitor (KHI) copolymer of Formula (I) to a natural gas stream:

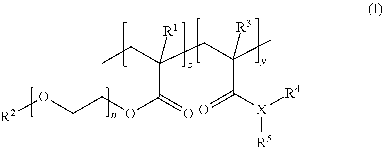

wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and

$$y + z = 1 ;$$

wherein the average molecular weight is from about 500 g/mol to about 10,000 g/mol; and
wherein R⁴ is absent when X is O or S;
thereby inhibiting the formation of gas hydrates in the natural gas.
   Embodiment 25. The method of embodiment 24, wherein X is N.
   Embodiment 26. The method of embodiment 24 or 25, wherein R¹, R², R³, R⁴, and R⁵ are each independently selected from the group consisting of H and C₁₋₆ alkyl.
   Embodiment 27. The method of any one of embodiments 24-26, wherein the composition comprises a solvent selected from an alcohol, an ether, a glycol, or combinations thereof.
   Embodiment 28. The method of any one of embodiments 24-27, wherein the natural gas is sour gas.
   Embodiment 29. The method of any one of embodiments 24-28, wherein the composition inhibits gas hydrate formation at a pressure of about 20 bars to about 200 bars.
   Embodiment 30. The method of any one of embodiments 24-29, wherein the composition inhibits gas hydrate formation at a temperature of about 0° C. to about 20° C.

What is claimed is:

1. A kinetic hydrate inhibitor (KHI) copolymer of Formula (I): 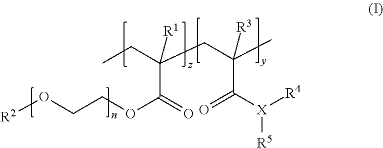
wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and
$$y + z = 1 ;$$
wherein the average molecular weight is from about 500 g/mol to about 10,000 g/mol; and
wherein R⁴ is absent when X is O or S.

2. The compound of claim 1, wherein X is N.

3. The compound of claim 1, wherein R¹, R², R³, R⁴, and R⁵ are each independently selected from the group consisting of H and C₁₋₆ alkyl.

4. The compound of claim 1, wherein R¹ is H.

5. The compound of claim 1, wherein R¹ is C₁₋₆ alkyl.

6. The compound of claim 1, wherein R² is C₁₋₆ alkyl.

7. The compound of claim 1, wherein R³ is H.

8. The compound of claim 1, wherein R⁴ is H.

9. The compound of claim 1, wherein R⁵ is C₁₋₆ alkyl.

10. The compound of claim 1, wherein n is 1 or 2.

11. The compound of claim 1, wherein z is 0.25, 0.5, or 0.75.

12. The compound of claim 1, wherein the average molecular weight is from about 500 g/mol to about 5,000 g/mol.

13. The compound of claim 1, wherein:
X is N;
R¹ is H or C₁₋₆ alkyl;
R² is C₁₋₆ alkyl;
R³ is H;
R⁴ is H
R⁵ is C₁₋₆ alkyl; and
n is 1 or 2.

14. The compound of claim 13, wherein R¹ is ethyl or methyl.

15. The compound of claim 13, wherein R² is ethyl.

16. The compound of claim 13, wherein R⁵ is isopropyl.

17. A method of preparing a KHI copolymer of claim 1, comprising:
reacting N-isopropyl acrylamide (NIPAM) with a monomer selected from 2-di(ethylene glycol) ethyl ether acrylate (DEGA) and ethoxyethyl methacrylate (EEM) in the presence of an azo initiator and a chain transfer agent; and
forming the KHI copolymer.

18. The method of claim 17, wherein the monomer is DEGA.

19. The method of claim 17, wherein the monomer is EEM.

20. The method of claim 17, wherein the azo initiator is selected from the group consisting of azoisobutyronitrile, 4,4′-azobis(4-cyanovaleric acid), 1,1′-azobis(cyclohexanecarbonitrile), 2,2′-azobis(2-methylpropionamidine) dihydrochloride, 2,2′-azobis(2-methylpropionitrile), 2,2′-azobis(2-methylpropionitrile), 2,2′-azobisisoheptonitrile, and 2,2′-azobis[2-(2-imidazolin-2-yl)propane]dihydrochloride.

21. The method of claim 20, wherein the azo initiator is 4,4′-azobis(4-cyanovaleric acid).

22. The method of claim 17, wherein the chain transfer agent is selected from the group consisting of thioglycolic acid, esters of thioglycolic acid, mercaptopropionic acid, esters of mercaptopropionic acid, mercaptobutanoic acid, and esters of mercaptobutanoic acid.

23. The method of claim 22, wherein the chain transfer agent is thioglycolic acid.

24. A method of inhibiting the formation of gas hydrates in natural gas, comprising:
adding a composition comprising a kinetic hydrate inhibitor (KHI) copolymer of Formula (I) to a natural gas stream: 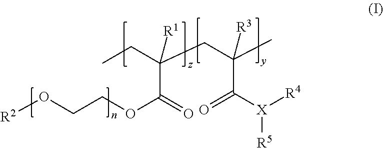
wherein:
X is N, O, or S;
R¹, R², R³, R⁴, and R⁵ are each independently selected from the group consisting of H, C₁₋₆ alkyl, —(C₁₋₄ alkyl)OR^{a}, —(C₁₋₄ alkyl)NR^{b}R^{c}, 6-10 membered aryl, 5-10 membered heteroaryl, —(C₁₋₄ alkyl)-6-10 membered aryl, —(C₁₋₄ alkyl)-5-10 membered heteroaryl, and —C(═O)CH═CH₂;
R^{a}, R^{b}, and R^{c} are each independently selected from the group consisting of H and C₁₋₆ alkyl;
n is 1, 2, 3, or 4; and
$$y + z = 1 ;$$
wherein the average molecular weight is from about 500 g/mol to about 10,000 g/mol; and
wherein R⁴ is absent when X is O or S;
thereby inhibiting the formation of gas hydrates in the natural gas.

25. The method of claim 24, wherein X is N.

26. The method of claim 24, wherein R¹, R², R³, R⁴, and R⁵ are each independently selected from the group consisting of H and C₁₋₆ alkyl.

27. The method of claim 24, wherein the composition comprises a solvent selected from an alcohol, an ether, a glycol, or combinations thereof.

28. The method of claim 24, wherein the natural gas is sour gas.

29. The method of claim 24, wherein the composition inhibits gas hydrate formation at a pressure of about 20 bars to about 200 bars.

30. The method of claim 24, wherein the composition inhibits gas hydrate formation at a temperature of about 0° C. to about 20° C.
